(19) United States
(12) Patent Application Publication
(10) Pub. No.: US 2025/0024981 A1
(43) Pub. Date: Jan. 23, 2025

(54) SOUS VIDE ASSEMBLY FOR USE IN A MICROWAVE OVEN

(71) Applicant: Haier US Appliance Solutions, Inc., Wilmington, DE (US)

(72) Inventor: Mark Heimerdinger, Louisville, KY (US)

(21) Appl. No.: 18/355,241

(22) Filed: Jul. 19, 2023

(51) Int. Cl. A47J 27/10; H05B 6/64

(52) U.S. Cl. CPC A47J 27/10; H05B 6/6408; A47J 2203/00

(57) ABSTRACT

A sous vide assembly for use in a microwave oven includes a tank to contain a volume of liquid and a basket positioned inside the tank. The basket includes a perforated bottom wall, vertical dividers within the basket to form food chambers, and a perforated cover mounted over the food chambers, the cover movable between a closed position and an open position. A gap is formed and maintained between the basket and the tank to allow a convection flow.

### FIELD OF THE INVENTION

The present subject matter relates generally to microwave oven appliances, and more particularly to systems for implementing sous vide cooking in microwave oven appliances.

### BACKGROUND OF THE INVENTION

Microwave oven appliances generally include a cabinet that defines a cooking chamber for receipt of food items for cooking. These appliances typically include one or more heating elements for generating energy to heat the food items during a cooking process. For example, microwave ovens typically include at least one source of electromagnetic radiation in the microwave frequency range, such as a cavity magnetron. In order to provide selective access to the cooking chamber and to contain food particles and cooking energy (e.g., microwaves) during a cooking operation, microwave appliances further include a door that is typically pivotally mounted to the cabinet.

Sous vide is a method of cooking that requires the application of low levels of heat (e.g., 130 to 160 degrees Fahrenheit) over the course of several hours (e.g., one or more hours, such as two or more hours, such as three or more hours, etc.). Even small temperature variations over the duration of the cooking operation can result in drastically different cooking outcomes. In sous vide, food is often cooked by sealing the food in a liquid-proof bag and submerging the bag in liquid that is maintained at the desired temperature. However, conventional sous vide assemblies for use in a microwave appliance may permit direct exposure of the food to microwave energy, which may quickly result in overcooking or uneven heating.

Accordingly, a microwave oven and sous vide assembly that facilitates improved sous vide cooking would be desirable. More specifically, a sous vide assembly that may be used in a microwave to facilitate a sous vide cooking process while preventing the exposure of food to undesirable levels of microwave energy would be particularly beneficial.

### BRIEF DESCRIPTION OF THE INVENTION

Aspects and advantages of the invention will be set forth in part in the following description, may be apparent from the description, or may be learned through practice of the invention.

In one exemplary aspect, a microwave oven defining a vertical direction, a lateral direction, and a transverse direction is presented. The microwave oven comprises a cabinet defining a cooking chamber, a door rotatably mounted to the cabinet for providing selective access to the cooking chamber, and a sous vide assembly configured for receipt within the cooking chamber. The sous vide assembly comprises a tank configured for containing a volume of liquid, a basket positioned inside the tank such that a convection gap is defined between the basket and the tank with the basket comprising a bottom wall defining a plurality of perforations. One or more vertical dividers is positioned within the basket and extending along the vertical direction to define a plurality of food chambers, and a cover defines a plurality of perforations. The cover is mounted over the one or more vertical dividers and being movable between an open position and a secured closed position to provide selective access to the plurality of food chambers.

In another exemplary aspect, a sous vide assembly for use in a microwave oven is provided, the microwave oven comprising a cabinet defining a cooking chamber. The sous vide assembly comprises a tank configured for containing a volume of liquid, a basket positioned inside the tank such that a convection gap is defined between the basket and the tank, the basket comprises a bottom wall defining a plurality of perforations. One or more vertical dividers is positioned within the basket and extends along the vertical direction to define a plurality of food chambers. A cover defines a plurality of perforations, the cover is mounted over the one or more vertical dividers and being movable between an open position and a secured closed position to provide selective access to the plurality of food chambers.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective front view of a microwave oven appliance in accordance with an example embodiment of the present disclosure;

FIG. 2 provides a perspective view of the exemplary microwave oven of FIG. 1 with the door in an open position according to exemplary embodiments of the present disclosure;

FIG. 3 provides a perspective view of a sous vide assembly that may be used in the exemplary microwave oven of FIG. 1 according to an exemplary embodiment of the present subject matter;

FIG. 4 provides a side, schematic view of the exemplary sous vide assembly of FIG. 3 according to an exemplary embodiment of the present subject matter; and

FIG. 5 illustrates a cyclic convective flow path of fluid developed in the sous vide assembly of FIG. 3 in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

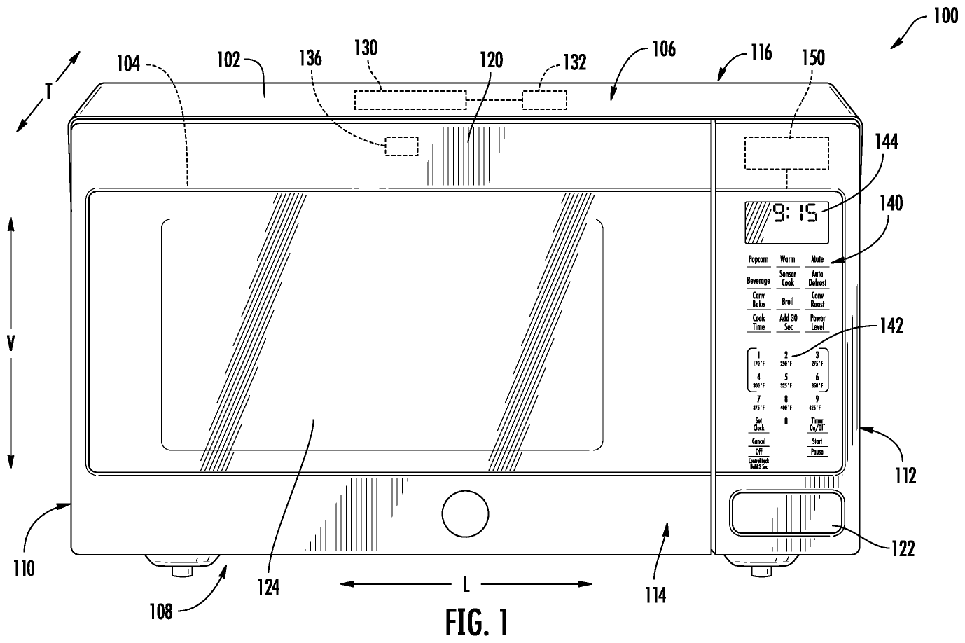

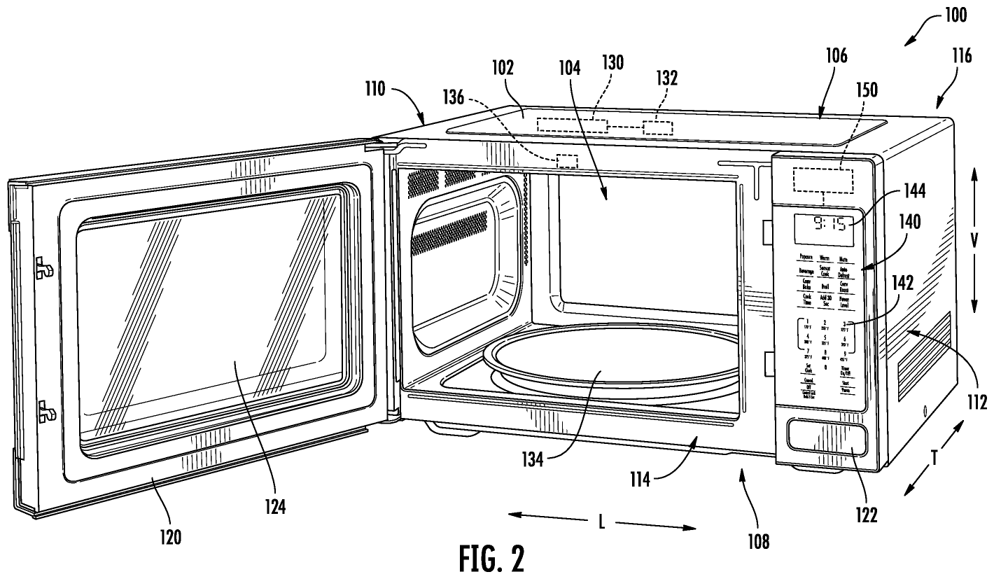

Turning to the figures, FIG. 1 provides a front view of a microwave oven appliance 100 as may be employed with the present subject matter and FIG. 2 provides a perspective view of microwave oven 100 with the door in an open position. Microwave oven 100 includes an cabinet 102 that defines a cooking chamber 104 for receipt of food items for cooking. As will be understood by those skilled in the art, microwave oven appliance 100 is provided by way of example only, and the present subject matter may be used in any suitable microwave oven, such as a countertop microwave oven, an over-the-range (OTR) microwave oven, etc. Thus, the example embodiment shown in the figures is not intended to limit the present subject matter to any particular cooking chamber configuration or arrangement.

As illustrated, microwave oven appliance 100 generally defines a vertical direction V, a lateral direction L, and a transverse direction T, each of which is mutually perpendicular, such that an orthogonal coordinate system is generally defined. Cabinet 102 of microwave oven appliance 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven appliance 100 includes a door 120 that is rotatably attached to cabinet 102 in order to permit selective access to cooking chamber 104. A handle (not shown) may be mounted to door 120 to assist a user with opening and closing door 120 in order to access cooking chamber 104. As an example, a user can pull on the handle mounted to door 120 to open or close door 120 and access cooking chamber 104. Alternatively, microwave oven appliance 100 may include a door release button 122 that disengages or otherwise pushes open door 120 when depressed. A window 124 may be provided for viewing the contents of cooking chamber 104 when door 120 is closed and also assist with insulating cooking chamber 104.

Microwave oven appliance 100 is generally configured to heat articles, e.g., food or beverages, within cooking chamber 104 using electromagnetic radiation. Microwave oven appliance 100 may include various components which operate to produce the electromagnetic radiation, as is generally understood. For example, microwave oven appliance 100 may include a microwave heating assembly 130 which may include a magnetron (such as, for example, a cavity magnetron), a high voltage transformer, a high voltage capacitor and a high voltage diode.

According to exemplary embodiments, microwave oven 100 may further include an inverter power supply 132 that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or inverter power supply 132 may include other suitable components, such as a capacitor that generally connects the magnetron and power supply, such as via high voltage diode, to a chassis. Microwave radiation produced by the magnetron may also be transmitted through a waveguide to cooking chamber 104.

As would be appreciated by one having ordinary skill in the art, inverter power supply 132 allows the magnetron's average electric field intensity to be adjusted between various power levels, such as between 10% and 100% of the total power capacity. By contrast, with conventional non-inverter power supplies, the electric field intensity is either 0% or 100%, and power levels are approximated using a timed duty cycle. For example, a non-inverter power supply set for a 50% power level would turn the magnetron ON at 100% output power for 15 seconds, and then OFF for 15 seconds. At power levels less than 100%, inverter power supply 132 has much better heating uniformity and less penetration depth which may be suitable for sous vide as the inverter power supply heats the water while avoiding direct heating of the food with microwave energy.

The structure and intended function of microwave ovens are generally understood by those of ordinary skill in the art and are not described in further detail herein. According to alternative embodiments, microwave oven may include one or more heating elements, such as electric resistance heating elements, gas burners, other microwave heating elements, halogen heating elements, or suitable combinations thereof, are positioned within cooking chamber 104 for heating cooking chamber 104 and food items positioned therein.

Microwave oven 100 may include additional features to improve heating uniformity and precision. For example, according to an exemplary embodiment, microwave oven 100 includes a turntable 134 rotatably mounted within cooking chamber 104. Turntable 134 may be selectively rotated during a cooking process to facilitate improved temperature uniformity for the object being heated.

Referring again to FIG. 1, a user interface panel 140 and a user input device 142 may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, microwave oven appliance 100 may include a controller 150 in operative communication with the user input device 142. The user interface panel 140 of the microwave oven 100 may be in communication with the controller 150 via, for example, one or more signal lines or shared communication busses, and signals generated in controller 150 operate microwave oven 100 in response to user input via the user input devices 142. Input/Output (“I/O”) signals may be routed between controller 150 and various operational components of microwave oven 100. Operation of microwave oven 100 can be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Aspects of the present subject matter are generally directed to systems and methods for implementing a sous vide cooking process in a microwave oven, such as microwave oven 100. More particularly, according to exemplary embodiments of the present subject matter, cooking chamber 104 is configured for receipt of a sous vide assembly 200 (e.g., on turntable 134) for facilitating a sous vide cooking process within microwave oven 100. According to exemplary embodiments, turntable 134 is rotated during the sous vide process for improved thermal uniformity. As would be appreciated by one having ordinary skill in the art, a sous vide cooking process is a type of cooking where a food item (such as an animal protein) is vacuum sealed in a bag and submerged in a bath of water maintained at a desired temperature until the meat reaches the desired internal temperature.

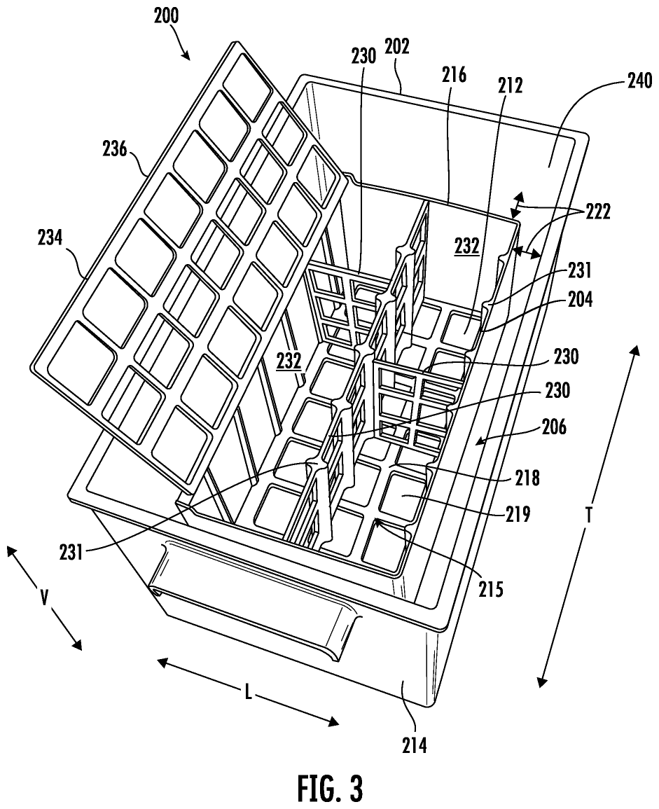

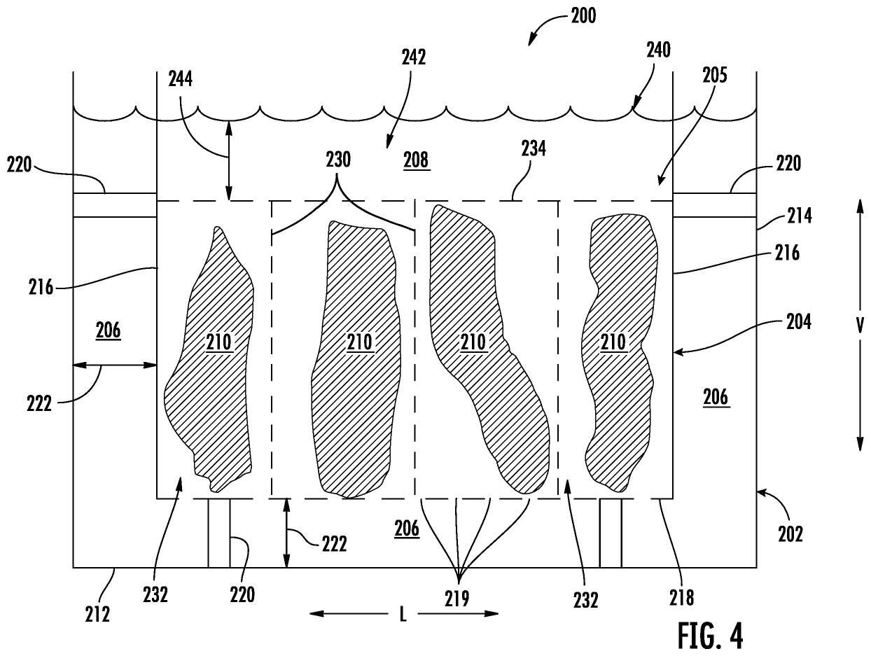

Referring now specifically to FIGS. 3 and 4, sous vide assembly 200 will be described in detail according to an exemplary embodiment of the present subject matter. As mentioned above, sous vide assembly 200 is generally configured for receipt within cooking chamber 104 of microwave oven 100 to facilitate a sous vide cooking process. However, it should be appreciated that the present subject matter is not limited to the specific construction of sous vide assembly 200 or to the particular application described, e.g., use within microwave oven 100.

Referring now to the figures, sous vide assembly 200 generally includes an outer tank, tank 202, and a basket 204 positioned inside tank 202 such that a convection gap 206 is defined between basket 204 and tank 202. In general, tank 202 may be a watertight, open-top container having a solid, generally impermeable bottom wall 212 and a solid, generally impermeable side wall 214 that are joined and configured for containing a volume of liquid (e.g., illustrated herein as water 208, FIG. 4). As illustrated in the embodiment represented in FIG. 4, the side wall 214 of the tank 202 may be comprised of a plurality (four shown) of portions joined together to form a solid, generally impermeable side wall 214 of a rectangular tank 202. In other embodiments, the tank 202 may have other shapes and a different number of side walls. For example, the tank may be generally round or oval and have one side wall that forms a watertight container. As will be explained in more detail below, microwave heating assembly 130 is generally configured for heating water 208 to facilitate a sous vide cooking process and cook a food item (e.g., identified herein generally by reference numeral 210) positioned within basket 204.

In general, basket 204 may comprise one or more generally vertical portions (four shown) joined to provide a generally solid, impermeable side wall 216. The side wall 216 is formed with, or connected to, a bottom wall 218 defining a plurality of perforations 219. Accordingly, bottom wall 218 is permeable and allows a flow of fluid, such as water 208, to pass through the perforations 219 in a generally vertical V direction.

In general, the shape of the basket 204, i.e., side wall 216 and bottom wall 218, will generally correspond to the shape of the tank 202 so that the basket 204 can be received within the tank 202 between tank spacers 220 forming a convection gap 206 between basket walls 216, 218 and tank walls 212, 214.

According to the illustrated embodiment, tank 202 and basket 204 are configured such that convection gap 206 is maintained throughout the sous vide cooking process. In some embodiments, the basket 204 and tank 202 are joined together with the convection gap 206 maintained. In other embodiments, the basket 204 is removably fit inside the tank 202 and separate from the tank. For example, according to the illustrated embodiment, sous vide assembly 200 may include a plurality of tank spacers 220 that are positioned between basket 204 and tank 202 to maintain convection gap 206. According to the illustrated embodiment, convection gap 206 is substantially constant around the sides and along the bottom of basket 204. However, it should be appreciated that convection gap 206 may vary according to alternative embodiments while remaining within the scope present subject matter. In this regard, for example, convection gap 206 may be larger where microwave energy is more intense, and vice versa.

In addition, tank spacers 220 and/or convection gap 206 may have any suitable size or dimension. For example, sous vide assembly 200 is generally sized and configured such that microwave energy penetrates the water 208 (FIG. 4) that is within convection gap 206 while the water 208 and food items 210 within basket 204 are not exposed to direct microwave energy. In this regard, as the microwave energy penetrates water 208, the electric field intensity decreases exponentially. When convection gap 206 is appropriately sized, substantially all of the microwave energy is absorbed within convection gap 206 (e.g., such that there is negligible direct cooking effect of the microwave energy on the food items 210). Accordingly, convection gap 206 may generally define a gap length 222 that is measured between tank 202 and basket 204. In this regard, gap length 222 may be measured perpendicular to tank 202 or as the shortest distance between a given point on tank 202 and the closest point on basket 204. According to exemplary embodiments, gap length 222 may be between about 15 millimeters and 40 millimeters, between about 10 millimeters and 30millimeters, or about 20 millimeters. It should be appreciated that gap length 222 may vary while remaining within the scope of the present subject matter. For example, the desirable gap length may vary based on the proximity of food items 210 to the tank, to the intensity of microwave energy, or based on any other suitable factors.

Notably, because microwave energy is intended only to penetrate into convection gap 206, the water 208 between the tank walls 212, 214 and the basket walls 216, 218 absorbs the microwave energy and no microwave energy, or almost no microwave energy, reaches the food items 210. Generally, the water 208 between the tank side wall 214 and the basket side wall 216 is heated by the microwave energy to a temperature greater than the temperature of the water 208 within the internal volume 215 of basket 204. The solid, impermeable side wall 216 of the basket 204 fluidly isolates the water 208 within the internal volume 215 from the water 208 in the convection gap 206. A cyclic convection flow path is generated to introduce warmed water from the convection gap 206 into the internal volume 215.

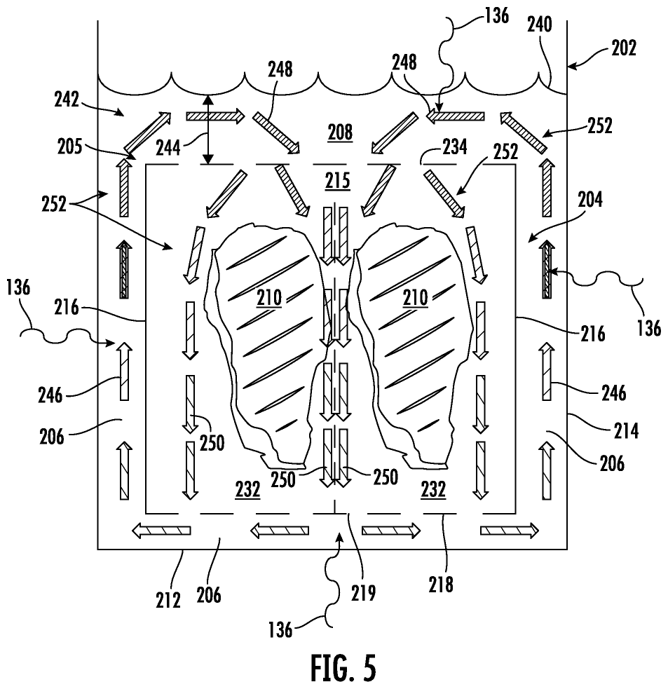

As illustrated in FIG. 5, microwave energy (represented by arrows 136) incident to the tank bottom wall 212 and side wall 214 penetrate partially into the convection gap 206. Similarly, microwave energy 136 incident to the water 208 at the target fill line 240 penetrates partially into the upper convection gap 242. As discussed above, all, or substantially all, of the microwave energy 136 directed to the water 208 is absorbed by the water within the convection gap 206 or the upper convection gap 242. The absorbed microwave energy raises the temperature of the water in the respective gaps 206, 242. As the water within the convection gaps 206 absorbs microwave energy 136, the warmed water 246 rises in the convection gaps 206 defining a plurality of convective flow paths 252 to the top 205 of the basket 204.

At the top 205 of the basket 204, mixed water 248 is formed from the warmed water 246 and cooled water 250 that has given up some heat energy to the food item 210 in the basket 204. The mixed water 248 is urged by the rising warmed water 246 to flow to the internal volume 215 of the basket 204. Concurrently, the warmed water 246 rising in the convection gaps 206 draws water through the basket internal volume 215 and through the perforated bottom basket wall 218. Thus, a plurality of cyclic convection flow paths 252 are created comprising the upward flow of warmed water 246 in the convection gap 206 and the downward flow of the cooled water 250 through the food chambers 232. The cooled water 250 is cooled in that it gives up some of its heat energy to the food items 210 in the food chambers 232 as the water flows downward through the internal volume 215. The cooled water 250 is heated by the microwave energy 136 and repeats the cycle.

Accordingly, water 208 within the basket 204 may be maintained at the desired temperature for the sous vide process by controlling the microwave energy that is imparted into convection gap 206 without exposing the food item 210 within basket 204 to direct microwave energy 136. This provides for a more controlled sous vide cooking process within basket 204.

As is generally recognized, raw food, for example animal protein, directly exposed to microwave energy tends to cook unevenly, with some areas cooking rapidly while others remain uncooked, or undercooked. To avoid exposure of food items to direct microwave energy, food items 210 are intended to be contained entirely within basket 204 and submerged in water 208 during the sous vide process. More specifically, according to the illustrated embodiment, sous vide assembly 200 further includes one or more vertical dividers 230 that are positioned within basket 204 and that extend substantially along the vertical direction V to define a plurality of food chambers 232. For example, according to the illustrated embodiment, sous vide assembly 200 includes three vertical dividers 230 that define four food chambers 232. As illustrated, for example in FIG. 4, a food item 210 may be positioned within each of the food chamber 232 during the sous vide cooking process. According to some embodiments, dividers 230 may include one or more chamber spacers 231 extending from the divider 230 into the food chamber 232 to minimize contact, or maintain spacing, between food items 210 in the food chamber 232 and the dividers 230. Chamber spacers 231 may facilitate the formation of a flow path of water 208 between the food item 210 and the divider 230. In some embodiments, one or more chamber spacers 231 may be provided on the basket side wall 216 to provide the same benefit.

In general, vertical dividers 230 are illustrated herein as dividing the inner portion of basket 204 into four compartments. However, it should be appreciated that according to alternative embodiments, any suitable number, size, configuration, and orientation of vertical dividers 230 may be used to form any suitable chamber configuration within inner tank 204. In general, food chambers 232 are sized such that one or more food items 210 may be positioned within each respective chamber 232 while providing sufficient space for water 208 to surround food items 210 and circulate within inner tank 204 for improved temperature uniformity throughout basket 204 and even sous vide cooking of the food item 210.

It may be desirable to ensure that food items 210 positioned in basket 204 remain submerged within water 208, e.g., to prevent direct exposure of food items 210 to microwave energy. Accordingly, sous vide assembly 200 may further include a cover 234 that is pivotally mounted over the one or more vertical dividers 230 and is movable between an open position (FIG. 3) and a secured closed position to provide selective access to the plurality of food chambers 232. For example, according to the exemplary illustrated embodiment, cover 234 is pivotally mounted to basket 204 and is movable between an open position (FIG. 3) to a closed position (shown schematically in FIG. 4) to function as the top wall of food chambers 232.

In embodiments, the cover 234 may prevented from unintentional movement from the closed position to an open position. For example, in the illustrative embodiment of FIG. 4, a clasp or latch 236 may be provided to engage a portion of the basket 204 when the cover 234 is in the closed position to resist unintentional movement from the closed position. In other embodiments, the latch 236 may be located on the basket 204, for example on the side wall 216 to engage a portion of the cover 234 when the cover 234 is in the closed position. The latch 236 may be any suitable device or configuration to selectively secure the cover 234 in the secure closed position. For example, latch 236 may be a friction fit, a snap fit, an interference fit, or a threaded fastener. The latch 236 may be a two-part device with a first part fixed to or formed with the cover 234 and a second part fixed to or formed with the basket 204.

For reasons similar to those described above with respect to convection gap 206, it is desirable that a top surface of water 208 is far enough above a top of food chambers 232 (i.e., cover 234) such that microwave energy does not directly enter food chambers 232 and cook food items 210. Accordingly, tank 202 may generally define a target fill line (e.g., identified generally by reference numeral 240) to which water 208 is filled prior to performing a sous vide cooking process. In addition, an upper convection gap 242 may generally be defined along the vertical direction V between the target fill line 240 and cover 234 when cover 234 is in the closed position. The cover 234 may prevent food items 210 from entering the upper convection gap 242 when the cover 234 is in the secured closed position.

According to exemplary embodiments, upper convection gap 242 may define an upper gap length 244 that is substantially equivalent to or greater than gap length 222. In this manner, all six sides surrounding basket 204 and food chambers 232 may have sufficient depth to prevent microwave energy from being directly exposed to food items 210 being cooked during the sous vide process. In this regard, it may be desirable to ensure that cover 234 is fully submerged by the upper convection gap 242, e.g., to ensure that the food item 210 is sufficiently below the target fill line 240 and the surface of the water 208.

As best illustrated in FIG. 4, food items 210 within food chamber 232 are generally surrounded by water 208 within the internal volume 215 of basket 204. Water 208 external to the basket 204 but within the tank 202 may cross the bottom wall 218 or the cover 234 of basket 204, but may not cross solid, generally impermeable basket side wall 216. As discussed above, water 208 within the convection gaps 206 between the basket 204 and tank 202 absorb microwave energy and is warmed. By natural, unforced convection, the warmed water rises (i.e., flows vertically upward) due to the decreased density of the warmed water in the convection gaps 206. When the warmed water reaches the top 205 of the basket 204, the flow of water encounters and mixes with water in the internal volume 215 of basket 204 that has yielded energy (i.e., given up heat) to the relatively cooler food items 210 through heat transfer (i.e., conduction and/or convection). The mixture of water is cooler than the warmed water in the convection gaps 206 and is urged to flow vertically downward through the interior (i.e., internal volume 215) of the basket 204, displaced by the flow of warmer water rising in the convection gaps 206. As the water 208 flows past the cooler food items 210, the water 208 gives up additional heat to the food items 210. As the food items 210 absorb energy (i.e., heat) from the flow of water, the density of the water 208 increases and the water 208 continues to flow vertically downward within the internal volume 215 of basket 204 and into convection gap 206 through the perforated basket bottom wall 218. Thus, by heating water 208 in the convection gaps 206, a cyclic convection flow path 252 of water within the sous vide assembly 200 is created.

The construction of the solid basket side walls 216 facilitates the creation of convection flow paths within the convection gaps 206 between the basket 204 and the tank 202. The water 208 in the convection gaps 206 between the side walls 214 and 216 of the tank 202 and the basket 204, respectively, is prevented from mixing with the cooler water within the internal volume 215 of basket 204. Accordingly, a vertically upward convective flow of warmed water 208 is established in the convection gaps 206 which may also facilitate the vertically downward flow of relatively cooler water through the internal volume 215 of the basket 204. The circular flow (vertically up in the convection gaps 206 and down through the internal volume 215 of the basket 204) is maintained by a temperature difference between the warmed water 208 and the relatively cooler food items 210. Over time, the temperature gradient between the water 208 and the food item 210 decreases as the food item 210 absorbs heat energy and is warmed to the temperature of the water 208. or within an established range of the temperature of the water 208 (i.e., equilibrium is reached). At the equilibrium point, or near equilibrium point, the sous vide process may cease.

According to exemplary embodiments, basket bottom wall 218, vertical dividers 230, and cover 234 may be formed from any suitable materials and have any suitable construction that permits water 208 to flow freely around and within food chambers 232. For example, according to exemplary embodiments, vertical dividers 230 and cover 234 are formed from perforated plates, mesh sheets, lattice structures, interwoven strips of material, or any other suitable material and construction. In this manner, water 208 within basket 204 (i.e., within the internal volume 215 of basket 204) may circulate freely between and among food chambers 232 such that there are minimal temperature gradients throughout food chambers 232 and inner tank 204. Water 208 within basket 204 may flow freely through the bottom wall 218 or through the cover 234 in communication with water 208 in the tank 202. Water 208 within the basket 204 is fluidly isolated from water in the convection gaps 206 formed between the solid side walls 216 of basket 204 and the tank side wall 214. Direct fluid communication through the side walls 216 of the basket 204 is prevented due to the solid, generally impermeable construction of side wall 216.

According to exemplary embodiments, basket 204, tank 202, vertical dividers 230, and cover 234 may be formed in any suitable manner and using any suitable material. For example, some or all of these components may be injection molded with a food-grade polymer material. Accordingly, it should be appreciated that various features of sous vide assembly 200 may be formed from any suitably rigid material. For example, according to exemplary embodiments, basket 204, tank 202, vertical dividers 230, and cover 234 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of sous vide assembly 200 may be formed from any other suitable rigid material.

As explained herein, aspects of the present subject matter are generally directed to a sous vide cooking fixture assembly for a microwave oven that may include an inverter power supply. The sous vide fixture may include two containers—an outer tank and an inner basket—with food dividers in the basket and a lid over the basket to prevent food from floating up to the surface of the water. The tank may be filled with water, absorbs microwave energy on all six sides, and with the walls of the basket creates convection gaps or flow paths to form a flow of warmed water to the internal volume of the basket. The basket may only absorb energy on top surface of water, thereby improving water temperature variation so that steaks or other food items can be cooked uniformly. The inverter power supply may be used to attain better heating uniformity than non-inverter power supply. According to exemplary embodiments, the sous vide fixture assembly is made of injection molded components.

In addition, or alternatively, aspects of the present subject matter are directed to a microwave oven utilizing a sous vide cooking technique. Generally, conventional counter-top sous vide cooking appliances use a separate immersion pump dipped into a sous vide reservoir that stirs and maintains water in the sous vide reservoir at a uniform temperature throughout the cooking process. Also, in a conventional microwave oven cooking process, microwave energy (as heat/temperature) may not adequately penetrate the food items to thoroughly cook the food, as the water in the food does not heat from direct microwave energy absorption. In order to overcome the aforementioned problems, aspects of the present subject matter integrate the microwave oven with the sous vide cooking technique and thereby eliminates the usage of separate counter-top sous vide appliances.

According to exemplary embodiments, a consumer selects the quantity of servings, the type of food, and the desired doneness from a selection menu. Then, the consumer may place the food in a vacuum-sealed bag or container and into the sous vide reservoir. The consumer may also use hot water in the sous vide reservoir to save time in heating water and may be prompted if the water is too hot from a tap for the food doneness selection, so that the consumer may then refill with cooler water.

According to exemplary embodiments, the microwave oven may further include temperature sensing and processing software for measuring the surface temperature of the water by means of a temperature sensor (e.g., an infrared temperature sensor) and power control software to regulate the microwave power delivered to the microwave cavity. For example, the temperature sensor may be placed within the microwave cavity for detecting water temperature. The water temperature measurement may provide feedback to the power control software, which may thereby regulate the surface temperature of the water at a sous vide set-point and prevent the food from overcooking. As the water absorbs the microwave energy, the power control software may regulate the temperature and reduce power until thermal equilibrium occurs. In this way, thermal gradient can be controlled that enables the sous vide cooking in the microwave oven without mechanical stirring.

For example, when a magnetron in the microwave oven is on, microwave field patterns randomize the patterns continuously across the surface of the water. This randomized energy absorption, combined with warm water convectively rising, causes variation across the surface of the water. By turning the magnetron off, and waiting a short time period, the temperature variation across the surface decreases, enabling a more accurate temperature measurement. Thereafter, the power control software may optimize the power level to the minimum, and the sous vide reservoir may be maintained at a uniform temperature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A microwave oven defining a vertical direction, a lateral direction, and a transverse direction, the microwave oven comprising:
a cabinet defining a cooking chamber;
a door rotatably mounted to the cabinet for providing selective access to the cooking chamber; and
a sous vide assembly configured for receipt within the cooking chamber, the sous vide assembly comprising:
a tank configured for containing a volume of liquid;
a basket positioned inside the tank such that a convection gap is defined between the basket and the tank, the basket comprising a bottom wall defining a plurality of perforations;
one or more vertical dividers positioned within the basket and extending along the vertical direction to define a plurality of food chambers; and
a cover defining a plurality of perforations, the cover mounted over the one or more vertical dividers and being movable between an open position and a secured closed position to provide selective access to the plurality of food chambers.

2. The microwave oven of claim 1, wherein the tank comprises a solid side wall connected to a solid bottom wall to form a water-tight reservoir.

3. The microwave oven of claim 1, wherein the basket comprises a solid side wall connected to the bottom wall defining an internal volume.

4. The microwave oven of claim 3, wherein the bottom wall provides fluid communication between the internal volume and the convection gap defined between the basket and the tank.

5. The microwave oven of claim 4, wherein the convection gap and the internal volume are in fluid isolation except through the bottom wall and the cover.

6. The microwave oven of claim 4, wherein the convection gap between the basket and the tank defines a plurality of convective flow paths.

7. The microwave oven of claim 1, wherein the cover is pivotally mounted to the basket.

8. The microwave oven of claim 1, further comprising a selectable latch wherein the cover is selectively secured in the secured closed position.

9. The microwave oven of claim 1, wherein the tank defines a target fill line, and wherein an upper convection gap is defined along the vertical direction between the target fill line and the cover in the secured closed position.

10. The microwave oven of claim 9, wherein the upper convection gap defines an upper gap length, the upper gap length being greater than or equal to a gap length of the convection gap.

11. The microwave oven of claim 1 wherein the basket side wall comprises one or more chamber spacers extending from the side wall into the food chamber.

12. The microwave oven of claim 1, wherein the one or more vertical dividers maintain lateral and transverse spacing between a content of a food chamber and a content of an adjacent food chamber.

13. The microwave oven of claim 12, wherein the one or more vertical dividers comprise chamber spacers extending from the vertical dividers into the food chamber.

14. The microwave oven of claim 1, further comprising a plurality of tank spacers positioned between the basket and the tank to maintain the convection gap.

15. The microwave oven of claim 1, wherein the basket and the tank are joined together with the convection gap maintained.

16. A sous vide assembly for use in a microwave oven, the microwave oven comprising a cabinet defining a cooking chamber, the sous vide assembly comprising:
a tank configured for containing a volume of liquid;
a basket positioned inside the tank such that a convection gap is defined between the basket and the tank, the basket comprising a bottom wall defining a plurality of perforations;
one or more vertical dividers positioned within the basket and extending along the vertical direction to define a plurality of food chambers; and
a cover defining a plurality of perforations, the cover mounted over the one or more vertical dividers and being movable between an open position and a secured closed position to provide selective access to the plurality of food chambers.

17. The sous vide assembly of claim 16, wherein the tank comprises a solid side wall connected to a solid bottom wall to form a water-tight reservoir; and
wherein the basket comprises a solid side wall connected to the bottom wall defining an internal volume, the bottom wall providing fluid communication between the internal volume and the convection gap defined between the basket and the tank.

18. The sous vide assembly of claim 16, wherein the convection gap defines a gap length, the gap length being about 20 millimeters.

19. The sous vide assembly of claim 16, wherein the tank defines a target fill line, and wherein an upper convection gap is defined along the vertical direction between the target fill line and the cover in the secured closed position.

20. The sous vide assembly of claim 16. wherein the one or more vertical dividers define a perforated portion to provide fluid communication among the plurality of food chambers.
